(19) United States
(12) Patent Application Publication
(10) Pub. No.: US 2023/0401469 A1
(43) Pub. Date: Dec. 14, 2023

(54) SYSTEMS AND METHODS FOR WEAKLY SUPERVISED UNIT TEST QUALITY SCORING

(71) Applicant: JPMORGAN CHASE BANK, N.A., New York, NY (US)

(72) Inventors: Georgios PAPADOPOULOS, London (GB); Alla NADEIN, Englewood Cliffs, NJ (US); Fanny SILAVONG, London (GB); Shanshan JIANG, West New York, NJ (US); Sean MORAN, London (GB); Rob OTTER, Witham (GB); Brett SANFORD, Tunbridge Wells (GB)

(21) Appl. No.: 17/933,302

(22) Filed: Sep. 19, 2022

(30) Foreign Application Priority Data
Jun. 10, 2022 (GR) 20220100485

(51) Int. Cl. G06N 7/00; G06F 8/35

(52) U.S. Cl. CPC G06N 7/005; G06F 8/35

(57) ABSTRACT

Systems and methods for weakly supervised unit test quality scoring are disclosed. According to one embodiment, a method may include: parsing, by a generative model computer program, a plurality of code snippets in a repository using an abstract syntax tree; receiving, by the generative model computer program, a plurality of binary labelling functions from a labelling function repository; creating, by the generative model computer program, a labelling matrix by applying the binary labelling functions to the parsed code snippets; training, by the generative model computer program, a probabilistic generative model using the labelling matrix resulting in a vector of pseudo-labels; building, by a unit test scoring computer program, a discriminative model, wherein the discriminative model receives an array of real value inputs; and training, by the unit test scoring computer program, the discriminative model using the parsed code snippets, the vector of pseudo labels, and the abstract syntax tree.

### RELATED APPLICATIONS

This application claims priority to, and benefit of, Greek Patent Application No. 20220100485, filed Jun. 10, 2022, and entitled SYSTEMS AND METHODS FOR WEAKLY SUPERVISED UNIT TEST QUALITY SCORING, the disclosure of which is hereby incorporated, by reference, in its entirety.

### BACKGROUND OF THE INVENTION

### 1. Field of the Invention

Embodiments relate generally to systems and methods for weakly supervised unit test quality scoring.

### 2. Description of the Related Art

Inadequate code inspection can cause significant amount of disruption to a business, loss of customer confidence, and hurt revenues. In some cases, badly developed and poorly inspected code can also have life-threatening effects.

Unit tests are often used to test units of an application to ensure that the unit meets its design and behaves as intended. For example, unit tests use test data to examine performance before an application is deployed. The results of the unit test are, however, only as good as the unit test itself; passing a poor-quality unit test will not necessarily mean that the application is robust.

### SUMMARY OF THE INVENTION

Systems and methods for weakly supervised unit test quality scoring are disclosed. According to one embodiment, a method for weakly supervised unit test quality scoring may include: (1) parsing, by a generative model computer program, a plurality of code snippets in a repository using an abstract syntax tree; (2) receiving, by the generative model computer program, a plurality of binary labelling functions from a labelling function repository; (3) creating, by the generative model computer program, a labelling matrix by applying the binary labelling functions to the parsed code snippets; (4) training, by the generative model computer program, a probabilistic generative model using the labelling matrix resulting in a vector of pseudo-labels; (5) building, by a unit test scoring computer program, a discriminative model, wherein the discriminative model receives an array of real value inputs; and (6) training, by the unit test scoring computer program, the discriminative model using the parsed code snippets, the vector of pseudo labels, and the abstract syntax tree.

In one embodiment, each binary labelling function may have a labelling threshold.

In one embodiment, each pseudo label may have a one-to-one relationship with a code snippet and weakly labels the code snippet as a positive test quality or a negative test quality.

In one embodiment, the method may also include mitigating, by the unit test scoring computer program, statistical issues from the probabilistic discriminative model.

In one embodiment, the method may also include: receiving, by the unit test scoring computer program, a unit test to be scored; parsing, by the unit test scoring computer program, the unit test to be scored into a plurality of code snippets to be scored using the abstract syntax tree; and scoring, by the unit test scoring computer program, the unit test to be scored using the trained discriminative model and a probability threshold. The method may also include outputting, by the unit test scoring computer program, the unit test score and an actionable explanation for the unit test score.

In one embodiment, the actionable explanation may include one or more reasons for the unit test score.

According to another embodiment, a system may include an electronic device comprising a computer processor and a memory storing a generative model computer program and a unit test scoring program; a code repository storing code; and a labelling function repository comprising a plurality of binary labelling functions. The generative model computer program may parse a plurality of code snippets from the code repository using an abstract syntax tree, may receive a plurality of binary labelling functions from a labelling function repository; may create a labelling matrix by applying the labelling functions to the parsed code snippets, and may train a probabilistic generative model using the labelling matrix resulting in a vector of pseudo-labels. The unit test scoring computer program may build a discriminative model, wherein the discriminative model receives an array of real value inputs, and may train the discriminative model using the parsed code snippets, the vector of pseudo labels, and the abstract syntax tree.

In one embodiment, each labelling function may have a labelling threshold.

In one embodiment, each pseudo label may have a one-to-one relationship with a code snippet and weakly labels the code snippet as a positive test quality or a negative test quality.

In one embodiment, the unit test scoring computer program may mitigate statistical issues from the probabilistic discriminative model.

In one embodiment, the unit test scoring computer program may receive a unit test to be scored, may parse the unit test to be scored into a plurality of code snippets to be scored using the abstract syntax tree, and may score the unit test to be scored using the trained discriminative model and a probability threshold.

In one embodiment, the unit test scoring computer program may output the unit test score and an actionable explanation for the unit test score.

In one embodiment, the actionable explanation may include one or more reasons for the unit test score.

According to another embodiment, a non-transitory computer readable storage medium, including instructions stored thereon, which when read and executed by one or more computer processors, cause the one or more computer processors to perform steps comprising: parse a plurality of code snippets in a repository using an abstract syntax tree; receive a plurality of binary labelling functions from a labelling function repository; create a labelling matrix by applying the binary labelling functions to the parsed code snippets; train a probabilistic generative model using the labelling matrix resulting in a vector of pseudo-labels; build a discriminative model, wherein the discriminative model receives an array of real value inputs; and train the discriminative model using the parsed code snippets, the vector of pseudo labels, and the abstract syntax tree.

In one embodiment, each labelling function has a labelling threshold, and each pseudo label may have a one-to-one relationship with a code snippet and may weakly label the code snippet as a positive test quality or a negative test quality.

In one embodiment, the non-transitory computer readable storage medium may also include instructions stored thereon, which when read and executed by one or more computer processors, cause the one or more computer processors to mitigate statistical issues from the probabilistic discriminative model.

In one embodiment, the non-transitory computer readable storage medium may also include instructions stored thereon, which when read and executed by one or more computer processors, cause the one or more computer processors to: receive a unit test to be scored; parse the unit test to be scored into a plurality of code snippets to be scored using the abstract syntax tree; and score the unit test to be scored using the trained discriminative model and a probability threshold.

In one embodiment, the non-transitory computer readable storage medium may also include instructions stored thereon, which when read and executed by one or more computer processors, cause the one or more computer processors to output the unit test score and an actionable explanation for the unit test score.

In one embodiment, the actionable explanation may include one or more reasons for the unit test score.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for weakly supervised unit test quality scoring according to an embodiment; and

FIG. 2 depicts a method for training a weakly supervised unit test quality scoring model according to an embodiment;

FIG. 3 depicts a method for inferring a weakly supervised unit test quality score according to an embodiment.

### DETAILED DESCRIPTION OF PREFERRED EMBODIMENTS

Embodiments relate generally to systems and methods for weakly supervised unit test quality scoring.

Embodiments may include a multistage algorithm that may use weakly supervised learning methods based on labelling functions to generate pseudo labels, and may then use supervised machine learning models that are trained on the pseudo labels to generate probabilities for the quality of the unit tests. The weakly supervised learning method may include a heuristic model that applies labelling functions based on abstract syntax tree and the code and offers an approximation to the true labels in order to train the supervised machine learning models.

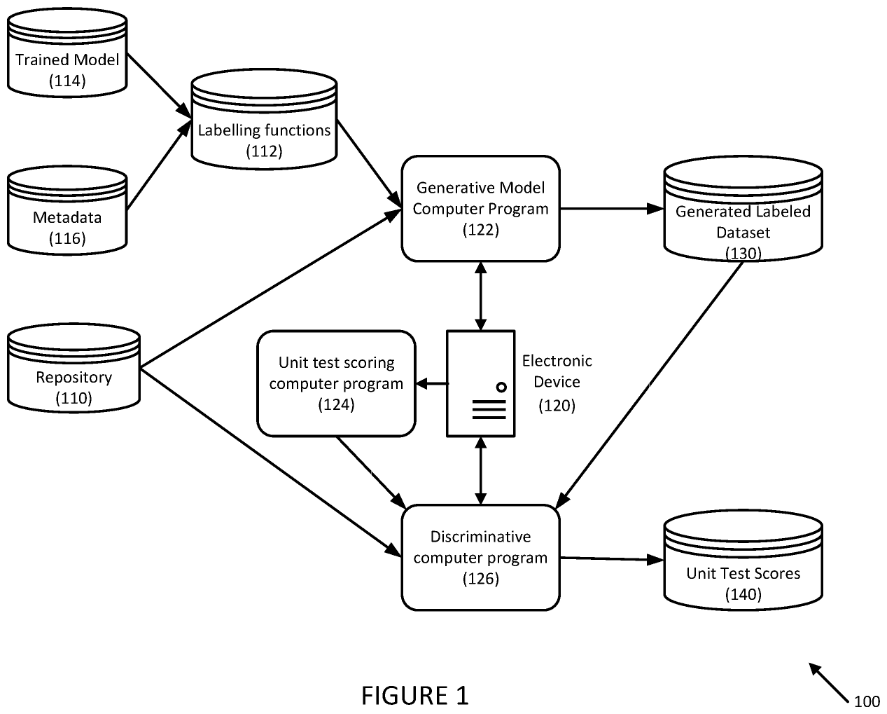

Referring to FIG. 1, a system for weakly supervised unit test quality scoring is disclosed according to an embodiment. System 100 may include repository 110, which may store code snippets of unit tests, and database 112 of labeling functions. The output of the labeling functions may be a binary output (e.g., positive/negative, pass/fail, go/no-go, “1” or “0”, etc.).

In one embodiment, the labeling functions in database 112 may include user-defined label functions and user-defined model functions. User-defined model functions may be similar to generic label functions, except that user defined model functions leverage information that may be defined separately from the label function, such as metadata or telemetry. For example, a user defined label function may search code for a keyword; if the keyword is found, the label function may return a positive label. A user defined model function, however, may review a number of code lines in a unit test. If the number of code lines is above the average for a unit test, which is typically stored in a database, the user defined model function may return a negative because the unit test may be more complex than needed.

In one embodiment, labeling functions may be based on trained model 114, metadata 116, from other arbitrary output, etc. In one embodiment, trained model 114 may be retrieved from a variety of locations (e.g., publicly trained model, or internally trained data), and metadata 116 may be sourced from a source code database (git), telemetry, etc. For example, the labeling functions may be based on historical vulnerabilities that may be stored in a database, or a newly secret detection ML model trained located in a database/hosted as API, etc.

The labeling functions may be constructed in collaboration with subject matter experts (SMEs). The labelling functions may be general enough in nature in order to capture as much information as possible so as to avoid ambiguous results, but also specific in terms that they can create unbiased groups. Examples of labelling functions may include a number of “asserts”, if an “assert” exists in a unit-test function, if an “assertNotNull” exists, the number of lines of a code snippet (logarithmic), etc.

In one embodiment, code snippets may be provided in real-time from, for example, applications, continuous integration/continuous deployment pipelines, integrated development environments, generic API calls, etc. Other sources may be used as is necessary and/or desired.

System 100 may further include electronic device 120, which may be any suitable electronic device, including servers (physical and/or cloud based), computers, etc. Electronic device 120 may execute generative model computer program 122 and unit test scoring computer program 124. Generative model computer program 122 may train a probabilistic model to output pseudo-labels and store the pseudo-labels in repository 130. Unit test scoring computer program 124 may train a discriminative computer program 126 to generate unit test scores, and may store the unit test scores in unit test score repository 140.

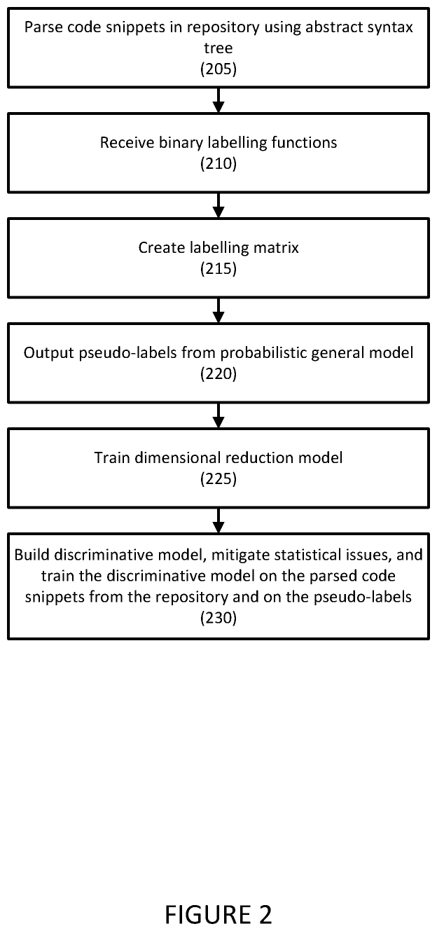

Referring to FIG. 2, a method for training a weakly supervised unit test quality scoring model is disclosed according to an embodiment.

In step 205, a generative model computer program may parse a code snippet of a unit test in a repository using, for example, an abstract syntax tree (AST). Using an AST not only maps the code snippet into a model readable format, but also keeps the structure of the underlying code intact for use with a weakly supervised model.

In step 210, the generative model computer program may receive labelling functions, such as binary labeling functions, from, for example, a repository. In one embodiment, user-defined labeling functions and/or user-defined modeling functions may be received as inputs.

In one embodiment, each labeling function may have its own threshold used to convert the vectors of pseudo labels to binary labels that may be defined by the user.

In step 215, the generative model computer program may create a labelling matrix. In one embodiment, the binary labelling functions may be used to create a labelling matrix, using the parsed code snippets as the input. For example, the generative model computer program may apply the labelling functions to the parsed code snippet and the code snippet in its original form and may generate the labelling matrix based on this application.

In one embodiment, each label function applied to the parsed code snippets and the code snippet in its original form may output a value. The outputs from all label functions may be used to populate the labelling matrix.

In step 220, the generative model computer program may use the labelling matrix as an input to train a probabilistic generative model. Using the labeling matrix, the probabilistic generative model may generate a vector of pseudo-labels. In one embodiment, the pseudo label may have a one-to-one relationship with the code snippet, with each label weakly labeling the code snippet as a positive or a negative quality of test. The probabilistic generative model may generate the pseudo-labels based on the relationship found in the labelling matrix.

In step 225, the generative model computer program may train a dimensional reduction model, using, for example, Principal Component Analysis (PCA). In one embodiment, the input to train the dimensional reduction model may be the AST.

In step 230, a unit test scoring computer program may build a discriminative model that may accept as inputs an array of real value inputs, such as time to execution, general code quality metrics, and the AST in its structural form. It may further mitigate any statistical issues from the probabilistic discriminative model. For example, the pseudo-labels from the probabilistic generative model may be biased for overfitting, poor robustness, etc. For example, the unit test scoring computer program may extract the AST features, randomly, split the dataset into training (80% or 200 items) and test data (20% or 50 items), taking into account class imbalance, vectorize the data into a normalized (TF-IDF) sparse matrix, reduce the AST sparse matrix dimensions and clean the data from noise by fitting a dimensionality reduction model (e.g., truncatedSVD) so that the resulted principal components, or PCs, explain at least 50% of the total training sample variance, normalize-fit the training data (e.g., StandardScaler) and transform the test data, and train a logistic regression model, using the training data as input and the pseudo-labels as target variables. Embodiments may apply a five-fold cross-validation method to avoid model overfitting.

After the inputs, the discriminative model may then be trained using the vector of pseudo-labels from the probabilistic generative model as target values.

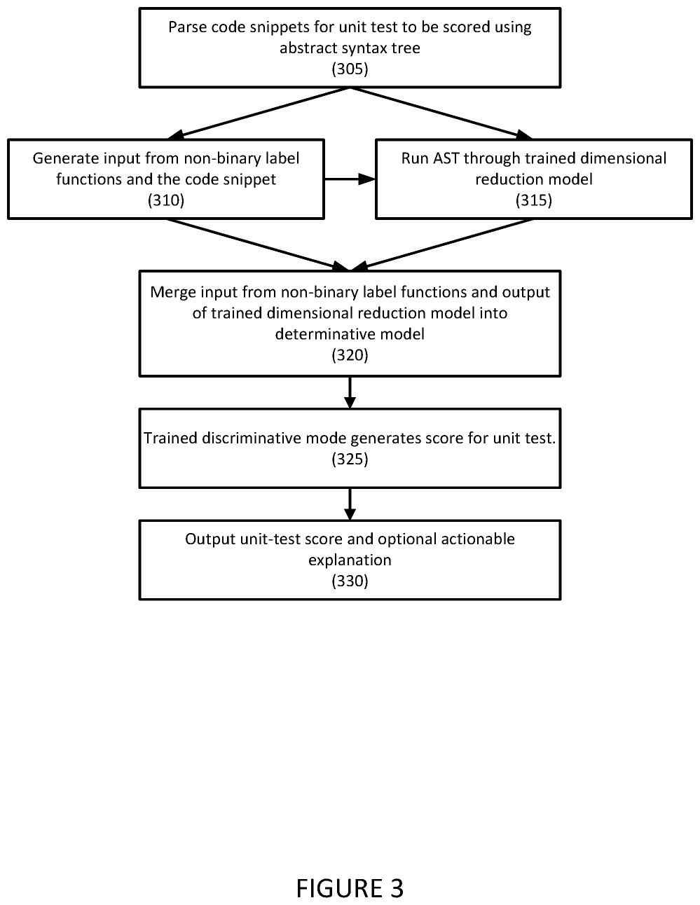

Referring to FIG. 3, a method for inferring a weakly supervised unit test quality score is disclosed according to an embodiment.

In step 305, a generative model computer program may parse a code snippet of a unit test to be scored using, for example, an abstract syntax tree (AST). This may be similar to step 205, above.

In step 310, the generative model computer program may generate input from non-binary label functions and the code snippet.

In step 315, the generative model computer program may run AST through the trained dimensional reduction model.

In step 320, the generative model computer program may merge the input from non-binary label functions and the output of trained dimensional reduction model into a discriminative model.

In step 325, the unit test scoring computer program may retrieve the score unit test using the trained discriminative model with a probability threshold. For example, if the unit test score that is output by the trained unit test scoring model is above the threshold (like 0.5), the unit test is considered to be positive, and if it is lower, negative. The unit test to be scored may be used as an input to the trained unit test scoring model to examine the application or software performance before deployment. In one embodiment, an inference graph may be used.

Illustratively, the probability threshold may be set at 0.5. The threshold may be set during training the unit test scoring, such as in steps 220 and 230, above. If the score is higher than 0.5, then it is a positive, and vice-versa. Other threshold values may be used as is necessary and/or desired. The value of the threshold may be the median, a weighted average depending on the underlying statistical distribution, combinations, etc. The thresholding method may be selected, for example, based on model performance from experimentations during model development.

Because it is trained on more data and features, and can thus be generalized better, the discriminative model may provide more accurate probabilities than the probabilistic model and may also be more robust in situations that have dataset bias. For example, the discriminative model may output accurate probabilities if a unit-test should be flagged or not.

In step 330, the unit test scoring computer program may output the unit test score and an optional actionable explanation. For example, the unit test scoring computer program may provide the positive and negative labels, and may also output the probability score (e.g., the numerical value). In one embodiment, the explanation may be output when the probability score is negative.

In one embodiment, the input and the weight of the discriminative model may be used to output the reason(s) causing low score, such as a lengthy unit test. Once the score is surfaced, the users may take any desired action based on the unit test score, including editing the unit test to improve its quality. Illustrative examples of outputs may include: EXPLANATION_HAS_ASSERT (e.g., “There are no ‘asserts’ in the unit-test function.”); EXPLANATION COUNT LINES (e.g., “The unit-test function is probably too large (too many lines of code).”): EXPLANATION COUNT ASSERT (e.g., “There are too many ‘assert’ statements in the unit-test function. The average number of ‘assert’ for a good unit-test is X” (the average number of assets may be based on statistical properties learned from the training data)).

Although multiple embodiments have been described, it should be recognized that these embodiments are not exclusive to each other, and that features from one embodiment may be used with others.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disc, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for training weakly supervised unit test quality scoring model, comprising:
parsing, by a generative model computer program, a plurality of code snippets in a repository using an abstract syntax tree;
receiving, by the generative model computer program, a plurality of binary labelling functions from a labelling function repository;
creating, by the generative model computer program, a labelling matrix by applying the binary labelling functions to the parsed code snippets;
training, by the generative model computer program, a probabilistic generative model using the labelling matrix resulting in a vector of pseudo-labels;
building, by a unit test scoring computer program, a discriminative model, wherein the discriminative model receives an array of real value inputs; and
training, by the unit test scoring computer program, the discriminative model using the parsed code snippets, the vector of pseudo labels, and the abstract syntax tree.

2. The method of claim 1, wherein each binary labelling function has a labelling threshold.

3. The method of claim 1, wherein each pseudo label has a one-to-one relationship with a code snippet and weakly labels the code snippet as a positive test quality or a negative test quality.

4. The method of claim 1, further comprising:
mitigating, by the unit test scoring computer program, statistical issues from the probabilistic discriminative model.

5. The method of claim 1, further comprising:
receiving, by the unit test scoring computer program, a unit test to be scored;
parsing, by the unit test scoring computer program, the unit test to be scored into a plurality of code snippets to be scored using the abstract syntax tree; and
scoring, by the unit test scoring computer program, the unit test to be scored using the trained discriminative model and a probability threshold.

6. The method of claim 5, further comprising:
outputting, by the unit test scoring computer program, the unit test score and an actionable explanation for the unit test score.

7. The method of claim 6, wherein the actionable explanation comprises one or more reasons for the unit test score.

8. A system comprising:
an electronic device comprising:
a computer processor; and
a memory storing a generative model computer program and a unit test scoring program;
a code repository storing code; and
a labelling function repository comprising a plurality of binary labelling functions;
wherein:
the generative model computer program parses a plurality of code snippets from the code repository using an abstract syntax tree;
the generative model computer program receives a plurality of binary labelling functions from a labelling function repository;
the generative model computer program creates a labelling matrix by applying the labelling functions to the parsed code snippets;
the generative model computer program trains a probabilistic generative model using the labelling matrix resulting in a vector of pseudo-labels;
the unit test scoring computer program builds a discriminative model, wherein the discriminative model receives an array of real value inputs; and
the unit test scoring computer program trains, the discriminative model using the parsed code snippets, the vector of pseudo labels, and the abstract syntax tree.

9. The system of claim 8, wherein each labelling function has a labelling threshold.

10. The system of claim 8, wherein each pseudo label has a one-to-one relationship with a code snippet and weakly labels the code snippet as a positive test quality or a negative test quality.

11. The system of claim 8, wherein the unit test scoring computer program mitigates statistical issues from the probabilistic discriminative model.

12. The system of claim 8, wherein the unit test scoring computer program receives a unit test to be scored, parses the unit test to be scored into a plurality of code snippets to be scored using the abstract syntax tree, and scores the unit test to be scored using the trained discriminative model and a probability threshold.

13. The system of claim 12, wherein the unit test scoring computer program outputs the unit test score and an actionable explanation for the unit test score.

14. The system of claim 13, wherein the actionable explanation comprises one or more reasons for the unit test score.

15. A non-transitory computer readable storage medium, including instructions stored thereon, which when read and executed by one or more computer processors, cause the one or more computer processors to perform steps comprising:
parse a plurality of code snippets in a repository using an abstract syntax tree;
receive a plurality of binary labelling functions from a labelling function repository;
create a labelling matrix by applying the binary labelling functions to the parsed code snippets;
train a probabilistic generative model using the labelling matrix resulting in a vector of pseudo-labels;
build a discriminative model, wherein the discriminative model receives an array of real value inputs; and
train the discriminative model using the parsed code snippets, the vector of pseudo labels, and the abstract syntax tree.

16. The non-transitory computer readable storage medium of claim 15, wherein each labelling function has a labelling threshold, and each pseudo label has a one-to-one relationship with a code snippet and weakly labels the code snippet as a positive test quality or a negative test quality.

17. The non-transitory computer readable storage medium of claim 15, further comprising instructions stored thereon, which when read and executed by one or more computer processors, cause the one or more computer processors to mitigate statistical issues from the probabilistic discriminative model.

18. The non-transitory computer readable storage medium of claim 15, further comprising instructions stored thereon, which when read and executed by one or more computer processors, cause the one or more computer processors to:
receive a unit test to be scored;
parse the unit test to be scored into a plurality of code snippets to be scored using the abstract syntax tree; and
score the unit test to be scored using the trained discriminative model and a probability threshold.

19. The non-transitory computer readable storage medium of claim 15, further comprising instructions stored thereon, which when read and executed by one or more computer processors, cause the one or more computer processors to output the unit test score and an actionable explanation for the unit test score.

20. The non-transitory computer readable storage medium of claim 19, wherein the actionable explanation comprises one or more reasons for the unit test score.
